(19) United States
(12) Patent Application Publication
(10) Pub. No.: US 2007/0272619 A1
(43) Pub. Date: Nov. 29, 2007

(54) Production of distinct water fractions

(76) Inventors: Pavol Banacky, Dunajska Luzna (SK); Balvinder Singh Rattan, Wanstead (GB)

Correspondence Address: KENYON & KENYON LLP, ONE BROADWAY, NEW YORK, NY, 10004, US

(21) Appl. No.: 11/656,038

(22) Filed: Jan. 19, 2007

Related U.S. Application Data
(60) Provisional application No. 60/760,818, filed on Jan. 20, 2006.

(51) Int. Cl. B01D 17/06

(52) U.S. Cl. 210/748; 210/243

(57) ABSTRACT

Method of preparation of two distinct water fractions by processing of starting bulk water, whereas resulting fractions are stabilized by ionic cheotropes as LDW-ES form of water clustering or by ionic kozmotropes as HDW-CS like unstructured form of water clustering, is the subject of the present invention. Based on the chemical character of dissolved salts in the starting bulk water, the two distinct water fractions can be prepared with the required properties. The fractions can be prepared for effective application at hydration of hyhrophobic or polar biologically active molecules, macromolecules of surfaces, cell membranes or to be an effective solvent for proteolytic or acido-basic reactions in general.

### FIELD OF THE INVENTION

The invention encompasses bulk water processing in order to produce bulk water with modified properties. The invention encompasses methods of processing bulk water processing to yield two different water fractions where each of the fractions has useful properties and can be used in different environments.

### BACKGROUND OF THE INVENTION

The extraordinary importance of water for living organisms and solution chemistry in general is directly related to the ability of water molecules to form an infinite hydrogen bonded network. The hydrogen bonding energy of water, 23 kJ/mol is much smaller than energy of covalent bonds, but large enough to form relatively stable, even fluctuating structures—clusters with the internal dynamics, dynamic equilibria and structural variability. See, S. J. Sareshand et al. “Hydrogen bond thermodynamic properties of water from dielectric constant data,” J. Chem. Phys. 113, 9727-9732 (2000).

There are hundreds of theoretical models of liquid water clustering, but only few of them have a convincing experimental support. The most realistic seems to be the model which estimate an average of 20 water molecules per flickering cluster over the temperature range 0-100° C., (H₂O)₂₀, the dodecahedron water cluster. See, Y. I. Jhon et al., “Equilibrium between two liquid structures in water. Explicit representation via significant liquid structure theory,” J. Mol. Liq., 111, 141-149 (2004). Dodecahedron water cluster has over 30 thousand symmetry distinct arrangements differing in energy. See, J. L. Kuo et al., “Short H-bonds and spontaneous self-dissociation in (H₂O)₂₀. Effect of H-bond topology,” J. Chem. Phys., 118, 3583-3588 (2003).

As H-bonding flickers between arrangements, two basic structural forms can be identified: expanded structure (ES) with a maximum of “ideal” non-distorted H bonds and with a dominance of H-bonding interactions, and puckered structure that is called collapsed structure (CS) which is formed by bending, elongation, or breaking of some H-bonds while to the stability of the cluster contribute significantly also nonbonding—van der Waaals interactions. Under normal conditions, there is dynamic equilibrium between these two structural forms.

This equilibrium can be shifted on the one or the other side and ES or CS structure can be stabilized by the presence of solutes—ions or molecules, which influence the extent of H-bonding and non-bonding interactions among water molecules. Water clusters can be disrupted, or even some H-bonds broken, under the influence of external electromagnetic field or within the regime of ultracavitation (ultrasonic energy source), but structural disruptions can hardly persist in pure-distilled water when external source of energy is removed. Fast relaxation processes can be expected, resulting in ES/CS equilibrium corresponding to the structural equilibrium at normal conditions.

Dodecahedron cluster, can form the center of larger structural unit of water—icosohedral water cluster, (H₂O)₂₈₀ which is about 3 nm in diameter. See, M. F. Chaplin, “A proposal for the structuring of water,” Biophys. Chem. 83, 211-221 (2000). If the central (H₂O)₂₀ dodecahedron cluster has ES form, then also the structural form of icosohedral water cluster (H₂O)₂₈₀, has ES character. If the central dodecahedron cluster has puckered CS form, also the structural form of icosohedral water cluster (H₂O)₂₈₀, has CS character. The ES structural form is less dense than CS form and water with dominance of ES form is called low density water (LDW). The CS form with deformed H-bond network is more dense (high density water (HDW)), and has lower specific heat Cp than ES form due to H-bond deformation and/or H-bond network disrupting. Under normal conditions, there is dynamic equilibrium between these two structural forms.

The experimental evidence for existence of CS form of icosohedral water cluster (H₂O)₂₈₀ follows from the agreement of the radial distribution function (O—O distance) of the model with X-ray data. See, A. H. Narten et al., “X-ray diffraction study of liquid water in the temperature range 4-200° C.,” Faraday Disc. 43, 97-107 (1967). Support for the clusters of ES form comes from the agreement with radial distribution function of solutions, supercooled water and water nanodroplets. See, A. Gaiger et al., “Water and aqueous solutions” (Hilger, Bristol, 1986), pg. 15; D. T. Brown et al., “Hydrophobic hydration and the formation of a clathrate hydrate,” Phys. Rev. Lett. 81, 4164-4167 (1998).

Presence of ions or molecules in water influences ES/CS water equilibrium due to interactions with surrounding water molecules, which in turn influence the water structuring in a different way depending on the character of ions or molecules. In general, ions that strongly interact with water (ion-water interaction is stronger than water-water interaction) form puckered arrangement of (H₂O)₂₀ dodecahedron cluster with a number of water molecules laying close to the ion causing bent and broken H-bonding network. The ES/CS equilibrium is then shifted toward CS cluster structural form, i.e. HDW water structure. On the other side, the ions which interact weaker with water then water interacts with other water molecules do not cause (H₂O)₂₀ dodecahedron cluster puckering and water around such an ions tend toward a convex dodecahedral arrangement, i.e. ES cluster structural form is formed—LDW water structure. The ions of the first group are called ionic kosmotropes and those of the second group are called ionic chaotropes.

Separation of ions on the groups of kosmotropes and chaotropes is closely related to the Hofmaister series in which ranking of ions is given in terms of their ability to stabilize the structure of proteins. This in turn is related to polar-hydrophilic and hydrophobic interactions at the hydration processes of different molecular/macromolecular systems.

There are convincing experimental evidences of the existence of ES/CS structured water due to presence of dissolved ions or due to water interaction with different molecular/macromolecular structures (hydration). Formation of H₃O⁺(H₂O)₂₀ dodecahedron cluster has been indicated by IR spectroscopy or mass spectroscopy. See, Miyazaki et al., “IR spectroscopy evidence for protonated water clusters forming nanoscale cages,” Science, 304, 1134-1137 (2004); Shin et al., “IR signature of structures associated with H⁺(H₂O)ₙ (n=6-27) clusters,” Science, 304, 1137-40 (2004); T. S. Zwier, Science, 304, 1119-1120 (2004); Hulthe et al., “Water clusters studied by mass spectroscopy,” J. Chromatogr. A, 77, 155-165 (1997). It has also been reported that at SO₄²⁻ anion solvation, SO₄²⁻ (H₂O)₁₆ clusters are formed. Plumridge et al., “Symmetry base simulation of hydration of small molecules,” Phys. Chem. Phys., 8 (2000). On the subject of small ions hydration a lot studies can be found, e.g. Z.-F. Wei et al., Observation of the first hydration layer of isolated cations and anions through the FTIR-ATR difference spectra, J. Phys. Chem. A109, 1337-1342 (2005), M. J. Bakker et al., Effect of ions on the structure and dynamics of liquid water, J. Phys. Cond. Matt. 17, S3215-3224 (2005), F. Sobott et al., Ionic clathrates from aqueous solutions detected with laser induced liquid beam ionization/desorption mass spectroscopy, Int. J. Mass Spectr. 185-7, 271-279 (1999), R. Leberman, et al., Effect of high-salt concentration on water structure, Nature 378, 364-366 (1995).

In general it has been found that ions that only weakly interact with water (ionic chaotropes: e.g., ClO₄⁻, NO₃⁻, I⁻, Br⁻, Cl⁻, F⁻, OH⁻, N(CH₃)₄⁺, NH₄⁺, Cs⁺, Rb⁺, K⁺) partition into and accumulate into LDW-ES cluster structural form of water, where they sit passively in dodecahedron water cluster and stabilize it. See, Dougherty, “Density of salt solutions: Effect of ions on the apparent density of water,” J. Phys. Chem. B, 105, 4514-4519 (2001). The ions stabilize also molecular structures that depend on the ES structural form of water. Molecular/macromolecular structures which are compatible with LDW-ES cluster structural form of water are those having hydrophobic character/surface, preferring hydrophobic interactions. See e.g., T. V. Chalikin, “Structural thermodynamics of hydration,” J. Phys. Chem. B, 105, 12566-12578 (2001); Wiggins, “High and low density water in gels,” Progr. Polym. Sci., 20, 1121-1163 (1995); Lin et al., “Anisotropic solvent structuring in aqueous sugar solutions,” J.A.C.S., 118, 12276-12286 (1996); S. Mashimo, “Structure of water in pure liquid and biosystem,” J. Non-crystaline Solids, 172-174, 1117-1120 (1994); Yaminsky et al., “Hydrophobic hydration,” Current Opinion Colloid Interface Sci., 6, 342-349 (2001); Widom et al., “The hydrophobic effect,” Phys Chem. Chem. Phys. 5, 3085-3093 (2003); D. Chonder, “Interfaces and the driving force of hydrophobic assembly,” Nature, 437, 640-647 (2005).

Hydrophobic hydration is primarily consequence of changes in clustering of surrounding water. Hydrophobic hydrations produce a reduction in density and an increase in heat capacity Cp of surrounding water, i.e. LDW-ES cluster structural form of water is formed. Gutmann, “Fundamental considerations about liquid water,” Pure Appl. Chem. 63, 1715-1724 (1991). In turn, stabilization of LDW-ES cluster structural form of water, stabilizes hydrophobic interactions.

Ionic kosmotropes (e.g., Al₃⁺, Mg₂⁺, Ca₂⁺, H⁺, Na⁺, citrate₃⁻, SO₄²⁻, HPO₄²⁻) are attracted to aqueous environment which provide more available hydration sites, i.e. to HDW-CS cluster structured water with disrupted H-bond network. These ions stabilize HDW water structure and stabilize molecular/macromolecular structures that prefer strong ionic-polar interactions. Hydration of polar molecular/macromolecular structures (polar hydration) increases the density of surrounding water clusters and decreases Cp due to their associated disorganized H-bonds network, i.e HDW-CS cluster structured water is formed. It has to be realized, however, that the strength of hydration of cations and anions is different and has different influence on donor/acceptor ability of H-bonded network.

Optimal stabilization of biological macromolecules by salts requires a well-balanced mixture of kosmotropic anion(s) with a chaotropic cation(s). Misbalance of this mixture results to instability of structure and loss of functionality of biological macromolecules. Different biological macromolecules or surfaces formed by these macromolecules or their parts require different ions composition, i.e. different water structuring. This is well documented by different concentrations of chaotropic K⁺ ions and kozmotropic Na⁺ and Ca²⁺ ions in intracellular and extracellular water. Concentration of Na⁺ ions in intracellular water is more than 150-times smaller than concentration of K⁺ ions. This concentration relation is exactly opposite for extracellular water. Ratio of Ca²⁺ ions concentration in intracellular/extracellular water is even lager, concentration of Ca²⁺ ions in intracellular water is nearly 10000-times smaller than Ca²⁺ ions concentration in extracellular water. Ion-pumps cannot produce such a large concentration differences. G. N. Ling, “Life at the cell and below-cell level. The hidden history of a functional revolution in Biology.” (Pacific Press, New York, 2001). Such a concentration difference is compatible, however, with different water structuring by ionic chaotrope K⁺ ions, i.e. LDW-ES cluster structural form of water, and HDW-CS cluster structural form of water which is created and stabilized by ionic kozmotropes Ca²⁺ and Na⁺. It has been confirmed by the experimental study (C. F. Hakelwood, A role of water in the exclusion in the inclusion of cellular sodium—Is a sodium pump needed?, Cardiovascular Diseases, Bull. Texas Heart Inst. 2, 83-104 (1975)), which has shown that NMR signal-widths are much broader inside cells, showing that intracellular water is far more structured preferring ionic cheotropes (i.e. LDW-ES cluster structural form of water) than extracellular water preferring ionic kozmotropes (HDW-CS cluster structural form of water) or pure water (ES/CS equilibrium).

### SUMMARY OF THE INVENTION

The invention encompasses a method of preparation of two distinct water fractions by processing of starting bulk water, whereas resulting fractions are stabilized by ionic cheotropes as LDW-ES form of water clustering or by ionic kozmotropes as HDW-CS like unstructured form of water clustering. Based on the chemical character of dissolved salts in the starting bulk water, the two distinct water fractions can be prepared with the required properties. The fractions can be prepared for effective application at hydration of hyhrophobic or polar biologically active molecules, macromolecules of surfaces, cell membranes or to be an effective solvent for proteolytic or acido-basic reactions in general.

### DETAILED DESCRIPTION OF THE INVENTION

Since there are in the field some patents related to electrolysis or electrodialysis of tap water to produce acidic water, sometimes called I-water and alkaline (basic) water, sometimes called S-water or ionized water in general (e.g. patents U.S. Pat. No. 5,846,397, U.S. Pat. No. 6,231,874, U.S. Pat. No. 5,624,544, WO/2005/085140, WO/2002/085794 and related patents referenced therein), the crucial element of novelty of the present Invention should be stressed. Mentioned patents are concerned mainly with resulting pH values of acidic and alkaline fractions. The main difference among these patents is basically in the technical aspects of the electrolytic device construction and in proposed application of respective fractions that is based usually on general declarations or subjective testimonies.

As it follows from the Background of Invention of the present patent, biological effect of water—in this case ability of water to hydrate different biological (macro)molecules depends mainly on the character (and concentration) of dissolved ions that influences water clustering in the form that is more or less convenient for hydrophobic or hydrophilic interactions. The element of novelty of the present Invention is that it discloses possibility to prepare two distinct water fractions and tune theirs hydration properties purposely based on dissolved ions composition of starting bulk water. For those skilled in the art it is clear that for instance if starting bulk water is diluted solution of KCl and in the other case diluted solution of CaCl₂ (or NaCl), by electrodialysis the two fractions, acidic and alkaline, are produced in both cases. The electrodialysis can be finished at the moment when e.g. the pH value of alkaline fractions is the same for both starting bulk water solutions. However, even the pH value of these alkaline fractions is the same theirs hydration abilities can be different due to different water clustering at hydration of K⁺ and Ca²⁺ (or Na⁺) cations since the former one is ionic cheotrope and the second one is ionic kosmotrope. On the other hand, hydration abilities of acidic fractions can be expected to be equivalent. In this way, if starting bulk water is tap water, then hydration abilities of alkaline and acidic fractions will depend on the mineral composition of the local water source. In some cases, however, a biological effect under consideration can depend mainly on an acido-basic reaction and in such a case pH itself can be dominant and water clustering due to dissolved salts can be masked.

Drinking water contains variable, but small amount of dissolved salts of different character, what depends on local geological conditions. In general, however, hard water is characteristic mainly by dissolved sulfates, MgSO₄, CaSO₄, and some chlorides, KCl and less amount of NaCl. In solution, beside small concentration of hydronium cations and hydroxide anions due to autodissociation of water molecules (characterized by pH value), dominant is presence of cations Mg²⁺, Ca²⁺, K⁺>Na⁺ and anions SO₄²⁻>Cl⁻. Consequently, electrolytic conductivity of drinking water is about 1000-times greater than electrolytic conductivity of distilled pure water where only hydronium cations and hydroxide anions are present due to autodissociation of water molecules.

Drinking water is basically unstructured. Concentration of dominant cations (Mg²⁺, Ca²⁺) and anions (SO₄²⁻) in solution is the same. All of these ions destroy LDW-ES form of water clustering, followed by tendency of ion-pairs formation. As a result, in drinking bulk water, like in distilled bulk water, there is no tendency to stabilize either ES or CS form of water clustering. In principle, this situation can be changed by preventing (decreasing) possibility of ion-pairs (Mg²⁺SO₄²⁻, Ca²⁺SO₄²⁻, K⁺Cl⁻, among others) formation in solution by change of the counter-ions concentration parity whereas charge parity has to be preserved.

Two distinct water fractions prepared by processing of starting bulk water as it is disclosed in this invention can be used at different medicinal applications, cosmetics applications, pharmaceutical applications and for chemical synthesis that assume water environment. Physico-chemical parameters of the two water fractions can be tuned to accommodate specific requirements for effective application of particular use, over the possibility to prepare starting bulk water of specific composition as it is disclosed on this invention.

The present invention encompasses methods for preparing two distinct water fractions, where the fractions are stabilized by ionic chaotropes as LDW-ES form of water clustering or by ionic kozmotropes as HDW-CS like unstructured form of water clustering. In one embodiment, electrodialysis of drinking water prepares two distinct water fractions.

During electrodialysis, an electrolytic cell is divided by semipermeable membrane on two separate compartments with an electrode installed in each of the compartments. In the present case, for electrodialysis of water to produce ES or CS clustered form of water fractions, the semipermeable membrane is optimal to be made of cellophane, but other materials of similar properties can also be used. The electrodes are made preferably of carbon or gold, respectively platinum in order to prevent possible contamination of water by toxic ions which can be produced by redox reactions on the electrodes (e.g. if electrodes, mainly anode, are made of stainless steel). Starting bulk water fills each compartment.

One of the electrodes is electrically connected to the positive pole and the second one to the negative pole of D.C. power external source, thus forming the anode with anodic compartment and cathode with cathodic compartment. By switching-on the D.C. voltage, the electric potential gradient starts electrodialysis. The anions move into anodic compartment undergoing a complex set of primary electrochemical and subsequent chemical reactions at the anode and in the anodic compartment, whereas the cations move into cathodic compartment undergoing a complex set of primary electrochemical and subsequent chemical reactions at the cathode and in the cathodic compartment. After some time of the processing, which depends on the electrolytic conductivity and ionic composition of the starting bulk water and on the D.C. voltage applied, the original homogeneous distribution of ion-pairs in starting bulk water is substantially changed. In comparison to the starting bulk water, distribution of ion-pairs becomes inhomogeneous and mainly, anodic and cathodic fractions are considerably different.

The anodic fraction is characteristic by: primary electrochemical process which is oxidation of hydroxide anions OH⁻; increased concentration of the other anions, i.e. mainly SO₄²⁻ (possibly Cl⁻) if starting bulk water is hard drinking water; and enrichment with anion kosmotrope SO₄²⁻ ions.

As a consequence, subsequent set of chemical reactions in anodic compartment results in:
increase of the concentration of hydronium H₃O⁺ ions, i.e. decrease of the pH value. Actual concentration of H₃O⁺ ions is directly related to the actual concentration of SO₄²⁻ (Cl⁻) anions in solution of the anodic compartment since H₃O⁺ cations are now counter ions to SO₄²⁻ anions, instead of Mg²⁺, Ca²⁺ (K⁺, Na⁺) that are counter ions in the starting bulk water.
For those skilled in the art it is clear that pH value of the anodic fraction can decrease down considerably, even to pH˜1.
Evolution of oxygen O₂ (with possibility of singlet oxygen ¹O₂ formation) and partially CO₂ (if the anode is made of carbon) and traces of Cl₂ which depends on concentration of chlorides in the starting water.
Possibility of H₂O₂, and HOCl formation and dissolution of O₂, and CO₂ in the anodic water fraction.

The cathodic fraction is characteristic by:
Primary electrochemical process which is reduction of hydronium cation H₃O⁺.
Increased concentration of the other cations, i.e. mainly Ca²⁺ (possibly K⁺+) but with decreased concentration of Mg²⁺ (due to 4000-times lower solubility of Mg(OH)² comparing to solubility of MgSO₄) if starting bulk water is hard drinking water.
Enrichment with cation chaotrope K⁺ ions and possible enrichment by cation kosmotrope Ca²⁺ ions.

As a consequence, subsequent set of chemical reactions in cathodic compartment results in:
Increase of the concentration of hydroxide OH− ions, i.e. increase of the pH value. Actual concentration of OH⁻ ions is directly related to the actual concentration mainly of K⁺ and Ca²⁺ (concentration of Mg²⁺ is minimal due to precipitation of Mg(OH)₂) cations in solution of the cathodic compartment since OH⁻ anions are now counter ions to Ca²⁺ and K⁺ cations, instead of SO₄²⁻ and Cl⁻ anions that are counter ions in the starting bulk water. For those skilled in the art it is clear that pH value of the anodic fraction can increase upward considerably, even to pH˜13.
Evolution of hydrogen.
Possibility of dissolution of H₂ in the cathodic water fraction.

For those skilled in the art, it is clear that if starting bulk water is not a drinking water but instead it is intentionally prepared as a diluted solution of some salts, substantially different composition and properties of the anodic and cathodic fractions can be obtained. For example, from the diluted solution of K₂SO₄ and diluted solution of MgSO₄ one can prepare basically the same anodic fractions, but cathodic fractions will be different. The cathodic fraction of K₂SO₄ solution processing will be considerably more stabilized as LDW-EC cluster structural form of water by the presence of cation cheotrope K⁺ ions, than cathodic fraction of MgSO₄ solution processing. Processing of the solutions of, e.g. K⁺, Na⁺, NH₄⁺, Ca²⁺, Mg²⁺, Al³⁺ salts of citrates, sulfates, dihydrogen-phosphates offers a lot of possibilities to produce cathodic and anodic fractions with required properties.

### EXAMPLE

The electrolytic cell is made of two ½ l cylinder-like glass containers. Between the open sides of the containers, the cellophane sheet is inserted and a gasket in this position tightly binds both containers. Tightly bounded cylinders are fixed in a horizontal position, and starting bulk water is introduced to both cylinders through the couple of holes that are drilled, one hole per cylinder, on the upper sides of cylinder walls. When both cylinders are about 90% filled by starting bulk water, influx of water is finished and couple of stick-shaped carbon electrodes, 8 mm of diameter, is introduced through the same holes into the starting water in both cylinders (one electrode per container). The electrodes are then electrically connected to the external D.C. power source and the applied voltage starts electrodialysis of starting bulk water. After 15 minutes, the pH value of the water fractions (anodic and cathodic compartments) is checked. If the pH values in anodic compartment is less than 5 or pH value in cathodic compartment is higher than 9, the processing of starting bulk water can be finished by switching-off the applied voltage. The electrodes are withdrawn from the compartments and the anodic and cathodic water fractions are poured-out (through the same holes where the electrodes were placed) into the separate containers. Time of starting bulk water processing can be shorter or longer than 15 minutes whereas at these circumstances, the anodic fraction is less acidic and cathodic fraction less basic or more acidic and more basic, respectively.

Particular processing, starting bulk water: hard drinking water of local source containing cations Mg²⁺>Ca²⁺>K⁺>>N+ and anions SO₄²⁻>>Cl⁻; electrolytic conductivity, 510 μS/cm, pH˜6.8; applied D.C. voltage: 200 V; time of processing: 15 min., anodic fraction: clear, acidic water fraction with partially dissolved oxygen and carbon dioxide, pH˜3.4; cathodic fraction: alkaline water with partially dissolve hydrogen and white precipitate of Mg(OH)₂ at the bottom of container, pH˜10.2.

Specific heat: measurements have been done by differential scanning calorimeter DSC-7 (Perkin-Elmer) with control module TAC-7/DX and software Pyris and nitrogen for samples degassing. The values below are average over temperature range 50-90° C. Starting bulk water: 4.1565 J/K/g; Cathodic fraction: 4.2391 J/K/g; Anodic fraction: 4.1436 J/K/g.

Optical activity: Angle of optical rotation: Starting bulk water: ˜−0.29°; Cathodic fraction: ˜+1.65°; Anodic fraction: ˜−0.29°.

Skin penetration effect: In-Vitro experiments were performed on fresh, intact human skin tissues. The fluorescent marker mithramycin was dissolved in particular water fraction and depth of skin penetration has been measured by a fluorescent microscopy technique.

Starting bulk water (the same results for distilled water): Minimal penetration effect, water overlay on the skin only surface.

Cathodic fraction (pH>7): Within 120 minutes no penetration of epidermis, but skin pores are well hydrated. It is an effective moisturizing effect, therefore possibility in cosmetics applications.

Anodic fraction (pH<7): Within 120 minutes the fraction penetrates through epidermis to dermis. Cell membrane penetration and cell membrane disintegration, therefore possibility to be used as (polar) drug delivery system.

We claim:

1. Preparation of two different water fractions by processing of starting bulk water, wherein:
one water fraction is enriched and structurally stabilized by ionic kosmotropes; and a second water fraction is enriched and structurally stabilized by ionic chaotropes

2. Electrodialysis as the method of processing of starting bulk water to produce two different water fractions of claim 1, wherein:
electrolytic cell is divided on two separate compartments by a semipermeable membrane; and in each of the separated compartments an electrode, or assembly of joined electrodes, is installed

3. Semipermeable membrane of claim 2 is:
made of cellophane or made of material of cellophane-like permeable and nontoxic properties based on cellulose derivatives;
made of inorganic or organic nontoxic material with cellophane-like permeable;
properties and which is stable over the pH range 1-14; or
made of nontoxic bipolar membrane which consist of anion-permeable membrane and cation-permeable membrane laminated together

4. The electrodes for electrodialysis of starting bulk water processing of claim 2:
are carbon, preferably of spectral purity carbon;
are both of gold or platinum; or
one is made of carbon and the second one of gold or platinum.

5. Process of starting bulk water electrodialysis of claim 2 for production of two different water fractions of claim 1 comprises the steps:
both compartments of the electrodialytic cell of claim 2 are filled by starting bulk water;
electrode (or assembly of joined electrodes) of one compartment is electrically connected to the positive pole of the external D.C. power source, and electrode (or assembly of joined electrodes) of the second compartment is electrically connected to the negative pole of the external D.C. power source, thus forming separated anodic and cathodic compartments;
applied D.C. voltage starts electrodialysis of starting bulk water and different water fractions, according to claim 1, are gathered in the anodic and cathodic compartments; and
processing of starting bulk water is finished by switching-off the D.C. voltage and by discharging the water fractions from anodic and cathodic compartments into separate containers, while the total time of electrodialysis depends on required physico-chemical parameters, e.g. pH values of the fractions.

6. The apparatus for the electrodialysis of claim 2, to produce different water fractions by processing of starting bulk water of claim 1, can be constructed either as an apparatus for batch processing or as an apparatus for continues processing of starting bulk water, and the apparatus can be provided by a single couple of anodic and cathodic compartments or can be provided by assembly of anodic and cathodic compartments.

7. Applied voltage of an external D.C. power source for electrodialysis of claim 5 is in the range of 50-500 V.

8. The starting bulk water of claim 1 is:
drinking water with electrolytic conductivity greater than 100 μS/cm and pH in the range of 6.5-7.5; or
dilute solutions preferably of Mg²⁺, Ca²⁺, K⁺, Na⁺ salts of sulfates, phosphates, citrates or chlorides with resulting electrolytic conductivity greater than 100 μS/cm.

9. Two different water fractions of claim 1, wherein:
comparing to the starting bulk water, the water fraction gathered in anodic compartment where positive electrode is immersed, is enriched by anion kozmotropes (e.g. SO₄²⁻) and hydronium ions and is characteristic by decreased pH value, by increased concentration of dissolved O2 and CO2 (if the anode of claim 4 is made of carbon) and by changed value of the specific heat CP;
comparing to the starting bulk water, the water fraction gathered in cathodic compartments where negative electrode is immersed, is characteristic by concentration decrease of anion kozmotropes (e.g. SO₄²⁻) as well as by concentration decrease of cation Mg2+ and hydronium ion kozmotropes and is enriched by cation chaotropes (e.g. K+) and hydroxide anions resulting in the increased pH value, while concentration of dissolved H2 can be increased and value of the specific heat CP is changed; and
water fractions from anodic and cathodic compartments can exhibit different optical activity, one exhibits left-handed and the second one right-handed optical rotation.

10. Different effects of the two water fractions of claim 9 on biological materials, wherein:
the water fraction from anodic compartment, claim 9a, is oxidative, biocidic and antibacterial having ability of cell membrane penetration and intracellular environment disintegration with affinity for hydrophilic hydration; and
the water fraction from catholic compartment, claim 9b, is reductive with affinity for hydrophobic hydration and higher compatibility with intracellular environment, having rather moisturizing skin effect.

11. Use of the water fractions of claim 9 in medicinal applications, pharmaceutical applications and cosmetics applications, whereas:
a water fraction is used as produced without addition of external additives;
a water fraction is used with external additives;
a water fraction is used to increase solubility of drugs or biologically active compounds;
a water fraction is used as a drug delivery system or biologically active compounds delivery system;
a water fraction is bound to a nontoxic natural or synthetic polymeric or olygomeric system, thus forming stable, water-rich, material (eg., hydrocolloids, or to hydrate sugars, polysaccharides, peptides, polypeptides, lipoproteins, lipids) which can be used as said by claim 11;
a water fraction is used for delivery of nucleic acids (dna, rna) to cells and tissue; and
a water fraction is used for delivery of cells for universal cell based therapies.

12. Use of the water fractions of claim 1 in chemical processes where the different properties of water fractions of claim 9 can be useful, wherein:
a fraction is used as a solvent facilitating proteolytic and acido-basic reactions or hydrophobic interactions;
a fraction is bound as the hydration water, e.g. process of cement hydration at a concrete hardening; and
a fraction is an optically active environment for synthesis of selected optical isomers.
